(19) United States
(12) Patent Application Publication
(10) Pub. No.: US 2025/0121805 A1
(43) Pub. Date: Apr. 17, 2025

(54) DEVICE FOR A BRAKE-BY-WIRE SYSTEM, PEDAL SYSTEM, BRAKE-BY-WIRE SYSTEM AND METHOD FOR A BRAKE-BY-WIRE SYSTEM

(71) Applicant: Infineon Technologies AG, Neubiberg (DE)

(72) Inventors: Sebastian BERNER, Munchen (DE); Andreas BARBUL, Munchen (DE); Konrad KAPSER, Grafelfing (DE); Johannes HUCHZERMEIER, Munchen (DE)

(21) Appl. No.: 18/894,217

(22) Filed: Sep. 24, 2024

(30) Foreign Application Priority Data
Oct. 12, 2023 (DE) 102023209993.4

(51) Int. Cl. B60T 8/171; B60T 7/04

(52) U.S. Cl. CPC B60T 8/171; B60T 7/04; B60T 2270/82

(57) ABSTRACT

A device for a brake-by-wire system of a vehicle is proposed. The device includes a distance sensor, which is configured: to sense a distance traveled by a first target that can be coupled to a brake pedal of the vehicle; to sense a distance traveled by a second target that can be coupled to the brake pedal; and a processing circuit, which is configured: to determine a difference between the distance traveled by the first target and the distance traveled by the second target; to determine based on the difference a force acting on the brake pedal; and to generate based on the force a control signal for activating a brake of the brake-by-wire system.

### CROSS-REFERENCE TO RELATED APPLICATION

This application claims priority to Germany Patent Application No. 102023209993.4 filed on Oct. 12, 2023, the content of which is incorporated by reference herein in its entirety.

### TECHNICAL FIELD

The present disclosure relates to brake-by-wire systems. Example implementations are concerned with a device for a brake-by-wire system of a vehicle, a pedal system for a brake-by-wire system of a vehicle, a brake-by-wire system and a method for a brake-by-wire system of a vehicle.

### BACKGROUND

Brake-by-wire systems traditionally measure the distance the brake pedal travels to activate the brake. However, this means that the actually intended braking force can only be adjusted to a limited extent. Furthermore, conventional brake-by-wire systems cannot detect mechanical blockages on the brake pedal. There is therefore a requirement for improved sensing of the braking movement.

### SUMMARY

This requirement is covered by the techniques described in the independent claims.

One example is concerned with a device for a brake-by-wire system of a vehicle, including: a distance sensor, which is configured: to sense a distance traveled by a first target that can be coupled to a brake pedal of the vehicle; to sense a distance traveled by a second target that can be coupled to the brake pedal; and a processing circuit, which is configured: to determine a difference between the distance traveled by the first target and the distance traveled by the second target; to determine based on the difference a force acting on the brake pedal; and to generate based on the force a control signal for activating a brake of the brake-by-wire system.

A further example is concerned with a pedal system for a brake-by-wire system of a vehicle, including: a device according to the implementation; the first target; and the second target.

A further example is concerned with a brake-by-wire system including: a pedal system according to the implementation; and the brake, wherein the brake is configured to exert a braking action on the vehicle based on the control signal.

A further example is concerned with a method for a brake-by-wire system of a vehicle, including: sensing using a distance sensor a distance traveled by a first target that can be coupled to a brake pedal of the vehicle; sensing using the distance sensor a distance traveled by a second target that can be coupled to the brake pedal; and determining using a processing circuit a difference between the distance traveled by the first target and the distance traveled by the second target; determining using the processing circuit based on the difference a force acting on the brake pedal; and generating using the processing circuit based on the force a control signal for activating a brake of the brake-by-wire system.

### BRIEF DESCRIPTION OF THE DRAWINGS

Some examples of devices and/or methods are explained in more detail below with reference to the accompanying figures merely by way of example. In the figures:

FIG. 1 shows an example implementation of a device for a brake-by-wire system;

FIG. 2 shows an example implementation of a pedal system for a brake-by-wire system;

FIG. 3 shows a further example implementation of a pedal system for a brake-by-wire system;

FIGS. 4a and 4b show diagrams, given by way of example, of an input signal and an output signal of a processing circuit of a device according to the implementation;

FIG. 5 shows an example implementation of a brake-by-wire system; and

FIG. 6 shows a flow diagram of an example implementation of a method for a brake-by-wire system.

### DETAILED DESCRIPTION

Some examples are now described in more detail with reference to the accompanying figures. However, further possible examples are not restricted to the features of these implementations which are described in detail. These may include modifications of the features and also equivalents and alternatives to the features. Furthermore, the terminology used herein to describe specific examples is not intended to be restrictive for further possible examples.

The same or similar reference signs relate throughout the description of the figures to the same or similar elements or features, which may each be implemented identically or else in a modified form, while providing the same or a similar function. In the figures, the thicknesses of lines, layers and/or regions may also be exaggerated for clarification.

When two elements A and B are combined using an “or”, this is to be understood as meaning that all possible combinations are disclosed, e.g., only A, only B, and also A and B, unless expressly defined otherwise in the individual case. “At least one of A and B” or “A and/or B” may be used as alternative wording for the same combinations. This applies equivalently to combinations of more than two elements.

If a singular form, for example “a, an” and “the”, is used, and the use of a single element is neither explicitly nor implicitly defined as mandatory, other examples may also use multiple elements to implement the same function. When a function is described in the following as being implemented using multiple elements, further examples may implement the same function using a single element or a single processing entity. Furthermore, it is understood that the terms “comprises”, “comprising”, “has” and/or “having” when used describe the presence of the indicated features, whole numbers, steps, operations, processes, elements, components and/or a group thereof, but do not thereby exclude the presence or the addition of one or more further features, whole numbers, steps, operations, processes, elements, components and/or a group thereof.

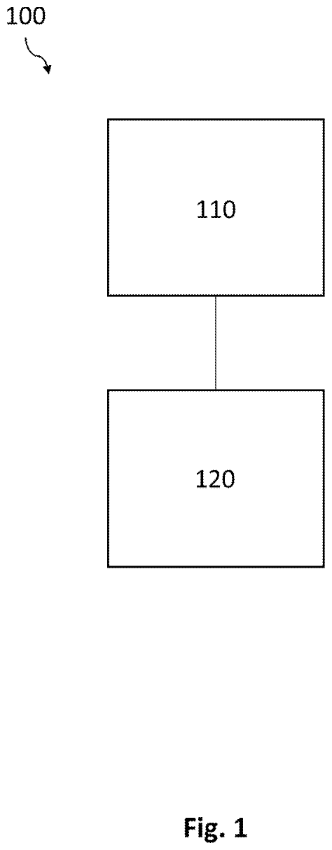

FIG. 1 shows an example implementation of a device 100 for a brake-by-wire system of a vehicle. The brake-by-wire system is an electronic braking system of the vehicle which at least partially replaces the mechanical connections between the brake pedal and the brakes. Instead of a physical brake booster or a hydraulic braking system, such a brake-by-wire system uses electronic signals to control the braking process. To do this, the brake pedal is sensed by a sensor which senses the braking movement applied by the driver to the brake pedal. This information is for example passed on to a control unit which controls the brake (for example brake calipers or brake pads) on the wheels of the vehicle. The electronic control unit interprets the braking-force signals and ensures adequate braking action at the individual wheels. This allows more precise and more individual control of the braking force, which is advantageous in particular for vehicles with electronic stability control systems or other driver assistance systems.

The device 100 may for example be integrated in the brake-by-wire system or be external to the brake-by-wire system and for instance be communicatively connected to the control unit or the brake by wired or wireless signal transmission techniques.

The device 100 comprises a distance sensor 110 and a processing circuit 120 (for example a measuring IC; integrated circuit). The distance sensor 110 may be any sensor for sensing a distance traveled, for example an incremental encoder or a linear distance sensor. An incremental encoder may for instance generate pulses which correspond to the changes in the position or movement of a target, e.g., they represent a relative displacement with respect to a reference point or a starting position. Such an incremental encoder can increase the resolution of the measurement.

The distance sensor 110 may be based on any physical principle, such as for example magnetic induction, Hall effect, optical scanning or capacitive measurement. The distance sensor 110 outputs for instance an output voltage or digital values that represent the measured distance.

In some example implementations, the distance sensor 110 comprises an inductive sensor or is an inductive sensor. An inductive distance sensor can measure a distance or a position of a target using the inductive principle. The inductive distance sensor comprises for example at least one coil, which generates for instance a high-frequency electromagnetic field. When a metallic target gets close to the sensor, it changes the electromagnetic field in the coil and causes a change in the inductance in the coil. This change in inductance is sensed by the sensor and converted into a corresponding electrical signal. Such an inductive distance sensor can be advantageous for a brake-by-wire application on account of its robustness, accuracy and low response time.

The processing circuit 120 may be for example a single dedicated processor, a single shared processor or a plurality of individual processors, some or all of which can be shared, a digital signal processor (DSP), an application-specific integrated circuit (ASIC), a microcontroller or a field programmable gate array (FPGA). The processing circuit 120 may optionally be connected to a read only memory (ROM) for storing software, a random access memory (RAM) and/or a non-volatile memory.

The distance sensor 110 and the processing circuit 120 are communicatively coupled, e.g., the processing circuit 120 receives measured values of the distance sensor via a signal connection between the distance sensor 110 and the processing circuit 120. The processing circuit 120 can for example pick off an output voltage of the distance sensor 110.

The distance sensor 110 is configured to sense a distance traveled by a first target that can be coupled to a brake pedal of the vehicle. The distance sensor 110 is also configured to sense a distance traveled by a second target that can be coupled to the brake pedal. The target may be any structure suitable as a position sensor. In the case of an inductive distance sensor, the target may for instance be a ferrite core or some other at least partially metallic, diamagnetic or magnetizable object.

The first target and the second target can be coupled to the brake pedal insofar as they can be mechanically connected to it—e.g., their movement or position indicates a movement or position of the brake pedal. They are connected to the brake pedal either directly or indirectly, via for example a spring. For example, it may be the case that the first target can be coupled to the second target via a spring. For example, the first target and the second target may be mechanically connected directly to different parts of the brake pedal, while these different parts are mechanically coupled to one another by a spring. The brake pedal may for instance comprise a footrest, which is coupled to the second target, and a main body, which is coupled to the first target, wherein the main body and the footrest are coupled using a spring.

The processing circuit 120 is configured to determine a difference between the distance traveled by the first target and the distance traveled by the second target and to determine based on the difference a force acting on the brake pedal. The processing circuit 120 is also configured to generate based on the force a control signal for activating a brake of the brake-by-wire system. The processing circuit 120 may pass on the control signal for example to a control unit of the brake or activate the brake itself in order to generate the braking action according to the calculated braking force on the brake pedal.

The processing circuit 120 may for instance obtain a respective position of or a respective distance traveled by the two targets as a measuring signal from the distance sensor 110 or determine this itself based on a measuring signal of the distance sensor 110. By calculating the difference between the two positions or distances, a force that acts on a spring coupled between the two targets can be determined. This force is determined based on a known spring constant of this spring and indicates the force acting on the brake pedal; it is for example proportional to the force acting on the brake pedal.

Compared to conventional techniques, the device 100 can allow the actual braking force to be determined, and not (just) the path traveled by the brake pedal. This can improve the activation and responsiveness of the brake of a brake-by-wire system. For example, different drivers may actuate the brake pedal with different intensities, resulting in different levels of braking force. The measurement of the braking force can ensure that a certain braking force is generated independently of the path traveled by the pedal. This ensures consistent braking, taking into account different respective driver usage. In addition, the determination of the braking force can allow the performance of the brakes to be monitored and potential problems to be detected at an early stage. This contributes to safety by detecting and rectifying possible defects or signs of wear before they cause the brakes to fail.

Furthermore, the device 100 may also increase the safety of the brake-by-wire system for the following reasons: During an unimpeded braking operation, the deflection (or deformation) of the spring or the difference in the distances may be small because both targets move with the braking movement: The deflection of the spring is then determined by the counterpressure from the main body of the brake pedal. The spring could for instance be preloaded, so that it normally pushes the first target away with a small deflection. However, a mechanical blockage of the first target would result in a greater deflection of the spring and thus a greater difference in the distances. In the event of such a blockage, this difference in distances can then be used to ensure that the brake continues to function-by deriving the braking force from this difference. With conventional means, it is difficult or impossible to detect a brake pedal blockage, whereas with the device 100 this is possible with high precision.

Accordingly, the processing circuit 120 may be configured to detect a mechanical blockage of the brake pedal based on the force. The detection of the blockage may be used for instance to send a warning signal to the driver or else to switch from conventional brake control to the control proposed here, using determining the path traveled by the pedal. The brake pedal may be blocked for various reasons, for example part of the brake pedal, for instance its spring mechanisms, may be damaged or blocked. This can cause the brake pedal to no longer be freely movable and no longer allow itself to be depressed (completely). Blockage may also be caused by foreign bodies entering the brake pedal area. These foreign objects may jam the pedal or otherwise interfere with its movement. The device 100 may be able to detect a blockage by both rigid and flexible bodies.

In some example implementations, the processing circuit 120 may also be configured to generate the control signal based on at least one out of the distance traveled by the first target and the distance traveled by the second target. This means that, in addition to the difference in the distances, the path traveled by the pedal can itself be used for controlling the brake. This can further increase the accuracy of the brake control. Alternatively, the latter-mentioned measuring and control principle may be used as a default, with a switch to control by difference in distances only being made in the event of a detected blockage. This makes it possible to simplify brake control without having to sacrifice the detection of blockages.

In the case of an inductive sensor, the distance sensor 110 may comprise the following: an excitation coil, a first periodic pair of secondary coils, which is configured to sense the distance traveled by the first target, and a second periodic pair of secondary coils, which is configured to sense the distance traveled by the second target. A respective pair of coils can therefore be provided to sense each of the targets individually, which increases the accuracy of the distance measurement.

For example, the periodic pairs of coils may be so-called cosine and sine coils. The coils of a pair of coils are then phase-shifted in their geometry by 90 degrees with respect to each other. When a target moves through the magnetic field of a pair of coils, the voltage generated by each coil of a pair of coils is modulated according to the cosine or sine value of the angle between the magnetic field and the axis of the coil. The position of the target can be calculated by measuring the voltages at both coils. The arc tangent from the induced voltages can be found in order to determine the angle by which the magnetic field has rotated relative to the coils, and thus also the angle by which the target has moved relative to the coils.

The excitation coil may be configured for instance to generate an electromagnetic coupling with the first and the second pair of secondary coils. Together with the pairs of secondary coils, it can improve the accuracy and sensitivity of the distance measurement. The excitation coil generates for instance a magnetic field which is cut through by the targets and generates an electrical signal which is sensed by the pairs of secondary coils. The use of excitation coils can therefore boost the magnetic field, which leads to a higher signal strength and thus contributes to an improved sensitivity of the distance measurement. The use of excitation coils can also help to reduce ambient disturbances that could affect the signal of the pairs of secondary coils. By generating a constant magnetic field, external influences such as electromagnetic disturbances or magnetic materials in the ambient environment can be isolated from the pairs of secondary coils.

The first and the second pair of secondary coils may be excited together by only one excitation coil. For example, the excitation coil may reach around both pairs of secondary coils. The use of a common excitation coil can save space, weight and cost. The control can also be simplified: Instead of controlling two separate coils independently of each other, a single control circuit may be used to control the common excitation coil.

The first and the second pair of secondary coils may also be planar or flat. This can allow simple manufacturing, for instance with printed circuit board technology. Furthermore, a planar geometry allows the pairs of secondary coils to be aligned more precisely and spatially arranged relative to the targets.

In some example implementations, the device 100 comprises a printed circuit board, which in turn comprises the distance sensor 110. For adjusting the distance sensor 110 to a curved path traveled by the pedal, the printed circuit board may be configured as at least partially arcuate. Thus, the distances of the distance sensor 110 from the targets in a direction not to be measured can be kept constant, in order not to falsify the measurements of the distance along a direction to be measured.

To achieve a high resolution of the force measurement, the number of periods of one of the pairs of secondary coils may be increased. For example, the first or the second pair of secondary coils may have a higher winding density than the other of the first or the second pair of secondary coils. In some example implementations, the second pair of secondary coils has a higher winding density than the first pair of secondary coils. This has the advantage that the aforementioned footrest is arranged close to the rest of the brake pedal and a spring length of the spring coupled between can be kept short. In such a case, the resolution can still be large enough to determine the braking force with sufficient accuracy. A small distance between the two brake pedal parts is advantageous insofar as the installation space of the brake pedal is not increased, or is increased only insignificantly, and a blockage of the footrest with respect to the rest of the brake pedal is also avoided.

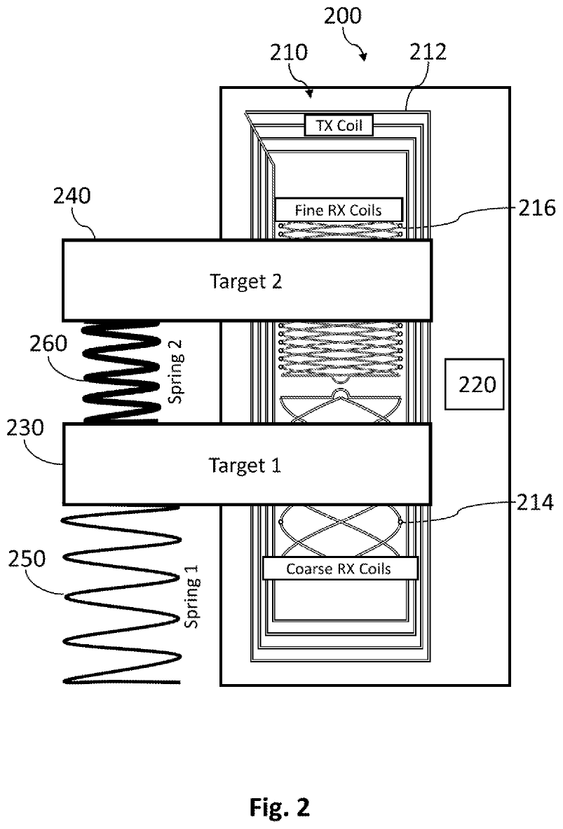

FIG. 2 shows an example implementation of a pedal system 200 for a brake-by-wire system of a vehicle. The pedal system 200 comprises a device 210 according to the implementation, for example the device 100 described above.

The device 210 comprises as distance sensor an inductive sensor, which comprises an excitation coil 212, a first periodic pair of secondary coils 214 and a second pair of secondary coils 216. The first periodic pair of secondary coils 214 is configured to sense a distance traveled by a first target 230. The second periodic pair of secondary coils 216 is configured to sense a distance traveled by a second target 240. The use of an inductive sensor in FIG. 2 should be understood as merely by way of example. As described with reference to FIG. 1, the distance sensor may be any sensor for sensing a respective distance traveled by the first target 230 and the second target 240.

In FIG. 2, the distance sensor is formed on a printed circuit board in a planar manner. Furthermore, the second pair of secondary coils 216 has a higher winding density than the first pair of secondary coils 214. The first pair of secondary coils 214 and the second pair of secondary coils 216 are arranged together within the pair of excitation coils 212. The geometry and arrangement of the pairs of coils 214, 216 should be understood here as an example. In other example implementations, the inductive sensor may for example comprise only one pair of secondary coils or two separate inductive sensors with a respective excitation coil and secondary coil. A further alternative would be a three-dimensional design of the coils without a printed circuit board or a curved shape of the printed circuit board.

The device 210 also comprises a processing circuit 220, which is configured to determine a difference between the distance traveled by the first target 230 and the distance traveled by the second target 240 and to determine based on the difference a force acting on a brake pedal of the pedal system 200. The processing circuit 220 is also configured to generate based on the force a control signal for activating a brake of the brake-by-wire system.

The pedal system 200 also comprises the first target 230 and the second target 240. In FIG. 2, the pedal system 200 also comprises a first spring 250, which is configured to couple the first target 230 to a vehicle frame (not shown) of the vehicle. As a result, a movement of the first target 230 indicates a distance traveled by the pedal with respect to the vehicle frame, which allows the determination of a desired braking action based on this distance.

In FIG. 2, the pedal system 200 also comprises a second spring 260, which is configured to couple the second target 240 to the first target 230. Such a spring 260 allows the determination of a desired braking action based on the difference in distances traveled by the two targets 230, 240. It should be noted here that the springs 250, 260 do not necessarily have to be mechanical springs as in FIG. 2: In other example implementations, the springs 250, 260 may also be elastic springs or gas springs.

In some example implementations, the second spring 260 is mechanically preloaded. This has the effect that, when the pedal is actuated, normally the first target 230 is pushed away from the second target 240 without causing a great deflection of the second spring 260.

When there is a blockage of the first target 230, on the other hand, there would be a greater deflection, which can be used to continue to operate the brake normally and/or to detect the blockage. In the case of a (for example elastic) blockage of the second target 240 with respect to the first target 230, on the other hand, there is an even smaller or no deflection—this too can be detected and does not affect the functionality of the brake.

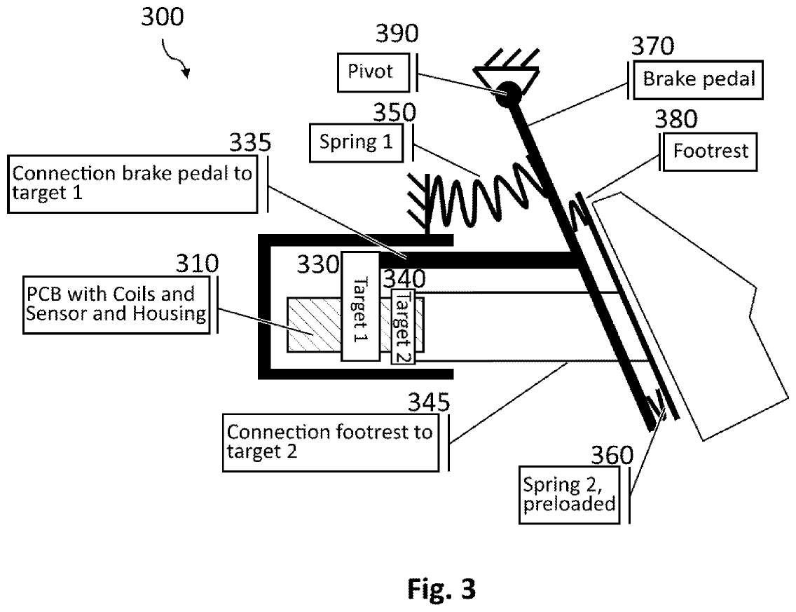

FIG. 3 shows a further example implementation of a pedal system 300 for a brake-by-wire system of a vehicle. The pedal system 300 comprises a device 310 according to the implementation, for example a device 100 or 210 as described above. The pedal system 300 also comprises the first target 330 and the second target 340.

The pedal system 300 also comprises a first spring 350, which is configured to couple the first target 330 to a vehicle frame of the vehicle. In the example of FIG. 3, the spring 350 is attached to a part 370 of the brake pedal, wherein the first part 370 is rigidly connected to the first target 330 via a connecting part 335.

The pedal system 300 comprises a second spring 360, which is configured to couple the second target 340 to the first target 330. In the example of FIG. 3, the spring 360 is attached to a footrest 380 of the brake pedal, wherein the footrest 360 is rigidly connected to the second target 340 via a connecting part 345. The footrest 380 is coupled to the rest 370 of the brake pedal, and thus to the first target 330, using the second spring 360.

The pedal system 300 also comprises an optional pivot joint 390 on the vehicle frame of the vehicle, wherein the part 370 of the brake pedal is rotatably mounted at the pivot joint 390.

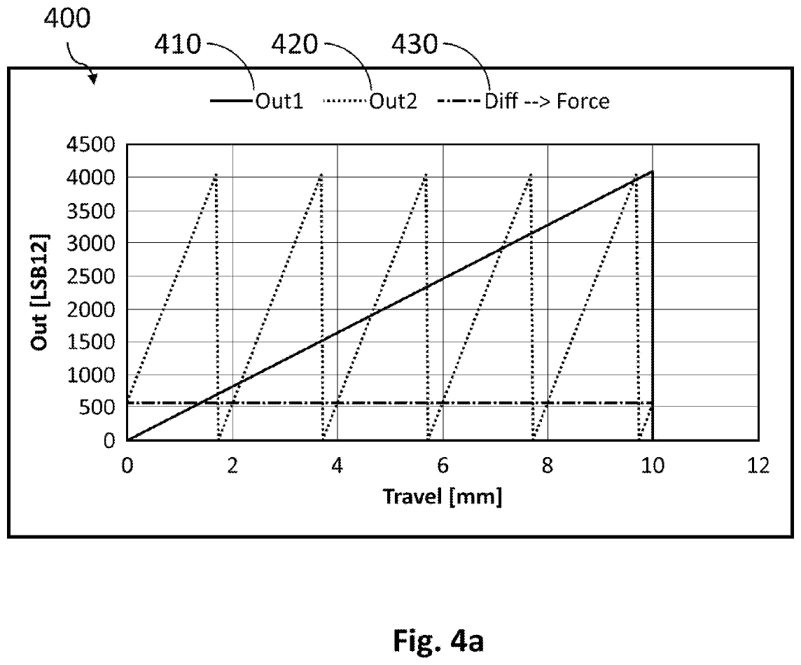

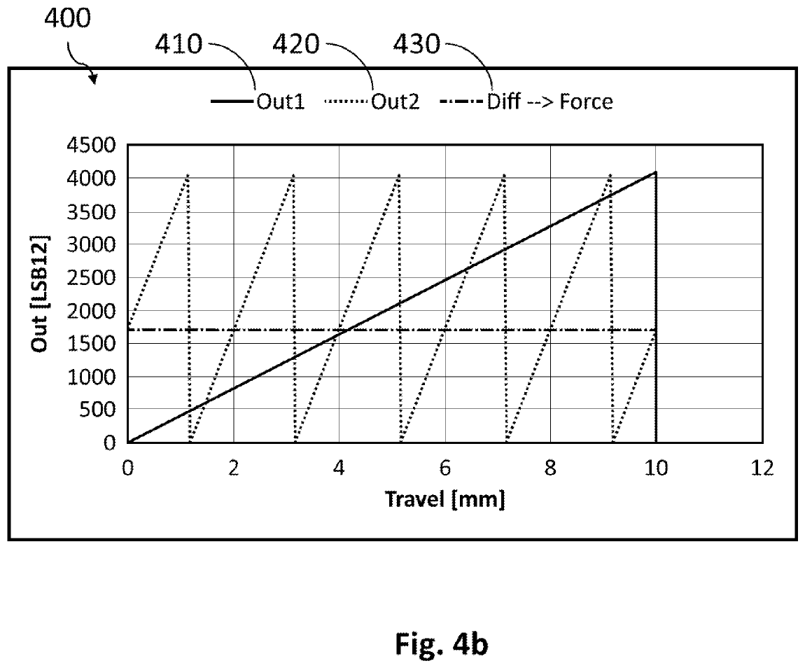

FIG. 4a and FIG. 4b show diagrams 400, given by way of example, of an input signal 410, 420 and an output signal 430 of a processing circuit of a device according to the implementation, for instance the device 100 or 210. The input signals 410, 420 indicate the respective distances traveled by a first target and a second target in millimeters (mm). The output signal 430 indicates the difference in distances traveled by the two targets, which results from the input signals 410, 420.

In an unblocked state of a brake pedal, a relatively small difference in distances is obtained, as shown in FIG. 4a. In a blocked state of the brake pedal, a greater difference in distances is obtained, as shown in FIG. 4b.

Based on the output signal 430, the processing circuit can determine a force acting on the brake pedal and generate based on the force a control signal for activating a brake of the brake-by-wire system. This is also possible if the brake pedal is mechanically blocked, as shown in FIG. 4b.

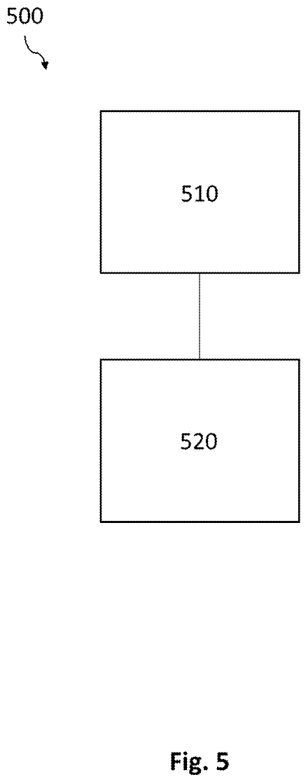

FIG. 5 shows an example implementation of a brake-by-wire system 500. The brake-by-wire system 500 comprises a pedal system 510 according to the implementation, for example the pedal system 200 or 300, and the brake 520. The brake 520 is configured to exert a braking action on the vehicle based on the control signal. For example, the brake 520 can be activated directly via the processing circuit of the pedal system 510 or via a control unit.

For example, the information acquired by the sensors in the pedal system 510 can be converted into control signals and transmitted to the brake 520. The brake 520 may comprise one or more actuators that generate the mechanical movement for actuating the brakes based on the control signals (or based on the output signal of the processing circuit). In the case of the brake-by-wire system 500, these may be electrical actuators which for instance generate hydraulic forces to generate the braking action.

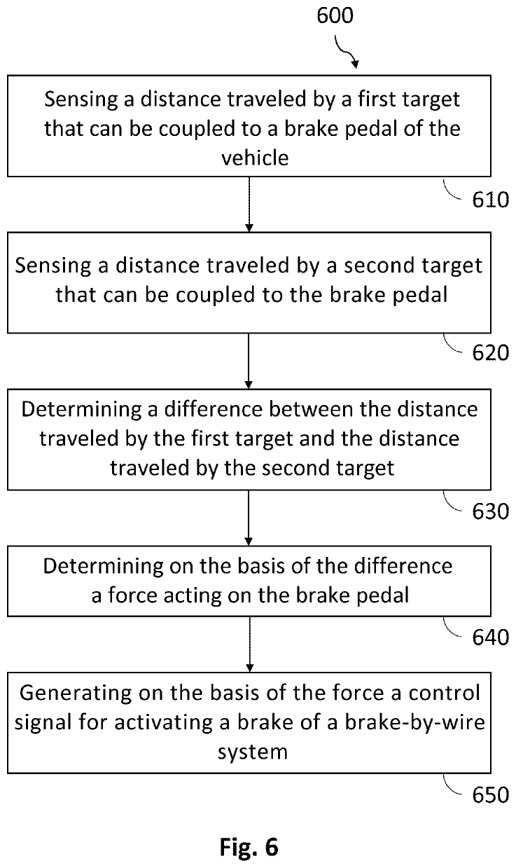

FIG. 6 shows a flow diagram of an example implementation of a method 600 for a brake-by-wire system of a vehicle. The method 600 can be carried out for instance by a device according to the implementation, for instance device 100.

The method 600 comprises sensing 610 using a distance sensor a distance traveled by a first target that can be coupled to a brake pedal of the vehicle; sensing 620 using the distance sensor a distance traveled by a second target that can be coupled to the brake pedal; and determining 630 using a processing circuit a difference between the distance traveled by the first target and the distance traveled by the second target. The method 600 also comprises determining 640 using the processing circuit based on the difference a force acting on the brake pedal and generating 650 using the processing circuit based on the force a control signal for activating a brake of the brake-by-wire system.

Further details of the method 600 are described based on the devices and systems with reference to FIGS. 1 to 5.

The devices and methods described above allow the actual braking force to be determined, not (just) the path traveled by the brake pedal. This can improve the activation and responsiveness of the brake of a brake-by-wire system. Furthermore, the devices and methods can increase the safety of the brake-by-wire system by a mechanical blockage being deduced from the deflection of a spring between first target and second target and for instance an operating mode of the brake-by-wire system being changed.

Further example implementations of the proposed techniques are described below:

A first example relates to a device for a brake-by-wire system of a vehicle, comprising: a distance sensor, which is configured: to sense a distance traveled by a first target that can be coupled to a brake pedal of the vehicle; to sense a distance traveled by a second target that can be coupled to the brake pedal; and a processing circuit, which is configured: to determine a difference between the distance traveled by the first target and the distance traveled by the second target; to determine based on the difference a force acting on the brake pedal; and to generate based on the force a control signal for activating a brake of the brake-by-wire system.

A second example relates to a device of a preceding example (for instance the first example), wherein the processing circuit is also configured to detect based on the force a mechanical blockage of the brake pedal.

A third example relates to a device of a preceding example (for instance one of the first and second examples), wherein the distance sensor comprises an incremental encoder.

A fourth example relates to a device of a preceding example (for instance one of the first to third examples), wherein the distance sensor comprises an inductive sensor.

A fifth example relates to a device of a preceding example (for instance the fourth example), wherein the inductive sensor comprises the following: an excitation coil, a first periodic pair of secondary coils, which is configured to sense the distance traveled by the first target, and a second periodic pair of secondary coils, which is configured to sense the distance traveled by the second target.

A sixth example relates to a device of a preceding example (for instance the fifth example), wherein the first and the second pair of secondary coils are planar.

A seventh example relates to a device of a preceding example (for instance one out of the fifth and sixth examples), wherein the excitation coil is configured to generate an electromagnetic coupling with the first and the second pair of secondary coils.

An eighth example relates to a device of a preceding example (for instance one out of the fifth to seventh examples), wherein the first or the second pair of secondary coils has a higher winding density than the other of the first or the second pair of secondary coils.

A ninth example relates to a device of a preceding example, also comprising a printed circuit board, wherein the printed circuit board comprises the distance sensor.

A tenth example relates to a device of a preceding example (for instance the ninth example), wherein the printed circuit board is at least partially arcuate.

An eleventh example relates to a device of a preceding example, wherein the processing circuit is also configured to generate the control signal based on at least one out of the distance traveled by the first target and the distance traveled by the second target.

A twelfth example relates to a pedal system for a brake-by-wire system of a vehicle, comprising: a device of one of the preceding examples; the first target; and the second target.

A thirteenth example relates to a pedal system of a preceding example (for instance the twelfth example), also comprising a first spring, which is configured to couple the first target to a vehicle frame of the vehicle.

A fourteenth example relates to a pedal system of a preceding example (for instance one out of the twelfth and thirteenth examples), also comprising a second spring, which is configured to couple the second target to the first target.

A fifteenth example relates to a pedal system of a preceding example (for instance the fourteenth example), wherein the second spring is mechanically preloaded.

A sixteenth example relates to a pedal system of a preceding example (for instance one out of the twelfth to fifteenth examples), also comprising the brake pedal, wherein the brake pedal has a footrest which is coupled using a spring to the rest of the brake pedal.

A seventeenth example relates to a brake-by-wire system, comprising a pedal system of one of the preceding examples and the brake, wherein the brake is configured to exert a braking action on the vehicle based on the control signal.

An eighteenth example relates to a method for a brake-by-wire system of a vehicle, comprising: sensing using a distance sensor a distance traveled by a first target that can be coupled to a brake pedal of the vehicle; sensing using the distance sensor a distance traveled by a second target that can be coupled to the brake pedal; and determining using a processing circuit a difference between the distance traveled by the first target and the distance traveled by the second target; determining using the processing circuit based on the difference a force acting on the brake pedal; and generating using the processing circuit based on the force a control signal for activating a brake of the brake-by-wire system.

The aspects and features described in connection with a particular one of the preceding examples may also be combined with one or more of the other examples to replace an identical or similar feature of this other example or to introduce the feature additionally into the other example.

Examples may also be or relate to a (computer) program with a program code for performing one or more of the above methods or refer to it, when the program is running on a computer, processor, or some other programmable hardware component. This means that steps, operations, or processes of various ones of the methods described above can also be performed by programmed computers, processors, or other programmable hardware components. Examples may also cover program memory devices, for example digital data storage media, which are machine-, processor-or computer-readable and which encode or contain machine-executable, processor-executable or computer-executable programs and instructions. The program memory devices may comprise or be for example digital memories, magnetic storage media, such as for example magnetic disks and magnetic tapes, hard disk drives or optically readable digital data storage media. Other examples may also cover computers, processors, control units, field-programmable logic arrays ((F)PLAs=(Field) Programmable Logic Arrays), field-programmable gate arrays ((F)PGA=(Field) Programmable Gate Arrays), graphics processors (GPU=Graphics Processor Unit), application-specific integrated circuits (ASIC=Application-Specific Integrated Circuit), integrated circuits (IC=Integrated Circuit), or one-chip systems (SoC=System-on-a-Chip) which are programmed to perform the steps in the methods described above.

It also goes without saying that the disclosure of multiple steps, processes, operations or functions disclosed in the description or claims shall not be construed as mandatory in the sequence described, unless this is explicitly stated in the individual case or is mandatory for technical reasons. Therefore, the previous description does not restrict the execution of multiple steps or functions to a specific sequence. Furthermore, in other examples, a single step, a single function, a single process or a single operation may include and/or be split into multiple sub-steps, -functions, -processes or -operations.

If some aspects have been described in the preceding sections in connection with a device or system, these aspects are also to be understood as a description of the corresponding method. In this case, for example, a block, a device or a functional aspect of the device or the system may correspond to a feature, such as a method step, of the corresponding method. Correspondingly, aspects described in connection with a method are also to be understood as a description of a corresponding block, a corresponding element, a property or a functional feature of a corresponding device or of a corresponding system.

The following claims are hereby incorporated into the detailed description, each claim being able to be independent as a separate example. It should also be noted that—although a dependent claim in the claims refers to a particular combination with one or more other claims—other examples may also comprise a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

### Aspects

The following provides an overview of some Aspects of the present disclosure:

Aspect 1: A device for a brake-by-wire system of a vehicle, comprising: a distance sensor configured to: sense a distance traveled by a first target coupled to a brake pedal of the vehicle, and sense a distance traveled by a second target coupled to the brake pedal; and a processing circuit configured to: determine a difference between the distance traveled by the first target and the distance traveled by the second target, determine, based on the difference, a force acting on the brake pedal, and generate, based on the force, a control signal for activating a brake of the brake-by-wire system.

Aspect 2: The device as recited in Aspect 1, wherein the processing circuit is configured to detect based on the force a mechanical blockage of the brake pedal.

Aspect 3: The device as recited in any of Aspects 1-2, wherein the distance sensor comprises an incremental encoder.

Aspect 4: The device as recited in any of Aspects 1-3, wherein the distance sensor comprises an inductive sensor.

Aspect 5: The device as recited in Aspect 4, wherein the inductive sensor comprises: an excitation coil; a first periodic pair of secondary coils, which is configured to sense the distance traveled by the first target; and a second periodic pair of secondary coils, which is configured to sense the distance traveled by the second target.

Aspect 6: The device as recited in Aspect 5, wherein the first and the second pair of secondary coils are planar.

Aspect 7: The device as recited in Aspect 5, wherein the excitation coil is configured to generate an electromagnetic coupling with the first and the second pair of secondary coils.

Aspect 8: The device as recited in Aspect 5, wherein the first or the second pair of secondary coils has a higher winding density than the other of the first and the second pair of secondary coils.

Aspect 9: The device as recited in any of Aspects 1-8, further comprising: a printed circuit board comprising the distance sensor.

Aspect 10: The device as recited in Aspect 9, wherein the printed circuit board is at least partially arcuate.

Aspect 11: The device as recited in any of Aspects 1-10, wherein the processing circuit is configured to generate the control signal based on at least one out of the distance traveled by the first target and the distance traveled by the second target.

Aspect 12: A pedal system for a brake-by-wire system of a vehicle, comprising: a first target; a second target; and a device comprising: a distance sensor configured to: sense a distance traveled by the first target coupled to a brake pedal of the vehicle, and sense a distance traveled by the second target coupled to the brake pedal; and a processing circuit configured to: determine a difference between the distance traveled by the first target and the distance traveled by the second target, determine, based on the difference, a force acting on the brake pedal, and generate, based on the force, a control signal for activating a brake of the brake-by-wire system.

Aspect 13: The pedal system as recited in Aspect 12, further comprising: a first spring configured to couple the first target to a vehicle frame of the vehicle.

Aspect 14: The pedal system as recited in any of Aspects 12-13, further comprising: a second spring configured to couple the second target to the first target.

Aspect 15: The pedal system as recited in Aspect 14, wherein the second spring is mechanically preloaded.

Aspect 16: The pedal system as recited in any of Aspects 12-15, further comprising: the brake pedal, wherein the brake pedal has a footrest which is coupled to the rest of the brake pedal using a spring.

Aspect 17: A brake-by-wire system, comprising: a pedal system comprising: a first target coupled to a brake pedal of the vehicle; a second target coupled to the brake pedal of the vehicle; and a device comprising: a distance sensor configured to: sense a distance traveled by the first target, and sense a distance traveled by the second target; and a processing circuit configured to: determine a difference between the distance traveled by the first target and the distance traveled by the second target, determine, based on the difference, a force acting on the brake pedal, and generate, based on the force, a control signal for activating a brake of the brake-by-wire system; and the brake, wherein the brake is configured to exert a braking action on the vehicle based on the control signal.

Aspect 18: A method for a brake-by-wire system of a vehicle, comprising: sensing, by a distance sensor, a distance traveled by a first target coupled to a brake pedal of the vehicle; sensing, by the distance sensor, a distance traveled by a second target coupled to the brake pedal; determining, by a processing circuit, a difference between the distance traveled by the first target and the distance traveled by the second target; determining, by the processing circuit, force acting on the brake pedal based on the difference; and generating, by the processing circuit, a control signal, for activating a brake of the brake-by-wire system, based on the force.

Aspect 19: A system configured to perform one or more operations recited in one or more of Aspects 1-18.

Aspect 20: An apparatus comprising means for performing one or more operations recited in one or more of Aspects 1-18.

Aspect 21: A non-transitory computer-readable medium storing a set of instructions, the set of instructions comprising one or more instructions that, when executed by a device, cause the device to perform one or more operations recited in one or more of Aspects 1-18.

Aspect 22: A computer program product comprising instructions or code for executing one or more operations recited in one or more of Aspects 1-18.

1. A device for a brake-by-wire system of a vehicle, comprising:
a distance sensor configured to:
sense a distance traveled by a first target coupled to a brake pedal of the vehicle, and
sense a distance traveled by a second target coupled to the brake pedal; and
a processing circuit configured to:
determine a difference between the distance traveled by the first target and the distance traveled by the second target,
determine, based on the difference, a force acting on the brake pedal, and
generate, based on the force, a control signal for activating a brake of the brake-by-wire system.

2. The device as claimed in claim 1, wherein the processing circuit is configured to detect based on the force a mechanical blockage of the brake pedal.

3. The device as claimed in claim 1, wherein the distance sensor comprises an incremental encoder.

4. The device as claimed in claim 1, wherein the distance sensor comprises an inductive sensor.

5. The device as claimed in claim 4, wherein the inductive sensor comprises:
an excitation coil;
a first periodic pair of secondary coils, which is configured to sense the distance traveled by the first target; and
a second periodic pair of secondary coils, which is configured to sense the distance traveled by the second target.

6. The device as claimed in claim 5, wherein the first and the second pair of secondary coils are planar.

7. The device as claimed in claim 5, wherein the excitation coil is configured to generate an electromagnetic coupling with the first and the second pair of secondary coils.

8. The device as claimed in claim 5, wherein the first or the second pair of secondary coils has a higher winding density than the other of the first and the second pair of secondary coils.

9. The device as claimed in claim 1, further comprising:
a printed circuit board comprising the distance sensor.

10. The device as claimed in claim 9, wherein the printed circuit board is at least partially arcuate.

11. The device as claimed in claim 1, wherein the processing circuit is configured to generate the control signal based on at least one out of the distance traveled by the first target and the distance traveled by the second target.

12. A pedal system for a brake-by-wire system of a vehicle, comprising:
a first target;
a second target; and
a device comprising:
a distance sensor configured to:
sense a distance traveled by the first target coupled to a brake pedal of the vehicle, and
sense a distance traveled by the second target coupled to the brake pedal; and
a processing circuit configured to:
determine a difference between the distance traveled by the first target and the distance traveled by the second target,
determine, based on the difference, a force acting on the brake pedal, and
generate, based on the force, a control signal for activating a brake of the brake-by-wire system.

13. The pedal system as claimed in claim 12, further comprising:
a first spring configured to couple the first target to a vehicle frame of the vehicle.

14. The pedal system as claimed in claim 12, further comprising:
a second spring configured to couple the second target to the first target.

15. The pedal system as claimed in claim 14, wherein the second spring is mechanically preloaded.

16. The pedal system as claimed in claim 12, further comprising:
the brake pedal, wherein the brake pedal has a footrest which is coupled to the rest of the brake pedal using a spring.

17. A brake-by-wire system, comprising:
a pedal system comprising:
a first target coupled to a brake pedal of the vehicle;
a second target coupled to the brake pedal of the vehicle; and
a device comprising:
a distance sensor configured to:
sense a distance traveled by the first target, and
sense a distance traveled by the second target; and
a processing circuit configured to:
determine a difference between the distance traveled by the first target and the distance traveled by the second target,
determine, based on the difference, a force acting on the brake pedal, and
generate, based on the force, a control signal for activating a brake of the brake-by-wire system; and
the brake, wherein the brake is configured to exert a braking action on the vehicle based on the control signal.

18. A method for a brake-by-wire system of a vehicle, comprising:
sensing, by a distance sensor, a distance traveled by a first target coupled to a brake pedal of the vehicle;
sensing, by the distance sensor, a distance traveled by a second target coupled to the brake pedal;
determining, by a processing circuit, a difference between the distance traveled by the first target and the distance traveled by the second target;
determining, by the processing circuit, force acting on the brake pedal based on the difference; and
generating, by the processing circuit, a control signal, for activating a brake of the brake-by-wire system, based on the force.
